(19) United States
(12) Patent Application Publication
(10) Pub. No.: US 2003/0011824 A1
(43) Pub. Date: Jan. 16, 2003

(54) Halftoning of lenticular images

(76) Inventor: Maurizio Pilu, Bristol (GB)

Correspondence Address: HEWLETT-PACKARD COMPANY, Intellectual Property Administration, P.O. Box 272400, Fort Collins, CO, 80527-2400, US

(21) Appl. No.: 10/186,808

(22) Filed: Jul. 1, 2002

(30) Foreign Application Priority Data
Jul. 4, 2001 (GB) 0116295.7

(51) Int. Cl. G06K 15/00; H04N 1/405

(52) U.S. Cl. 358/3.06

(57) ABSTRACT

A method of producing a halftone lenticular image from multiple images which are divided into image strips and the strips interleaved to form a lenticular image involves the image strips of each original image being processed separately from those of other original images to produce corresponding halftone dot printing values for printing the dots of the halftone lenticular image. An appropriate processor can be programmed to carry out such a method. Improved halftone lenticular images are a result.

### FIELD OF THE INVENTION

This invention relates to the halftoning of lenticular images.

### BACKGROUND OF THE INVENTION

A lenticular image is formed on the rear surface of a transparent lenticular sheet having a front surface formed with a plurality of parallel evenly spaced ridges. Each ridge is formed as a cylindrical lens and is aligned with a corresponding stripe of the lenticular image on the rear surface. Each lenticular stripe is subdivided into multiple longitudinal image elements or strips so that one image strip of each lenticular stripe combines with corresponding strips from the other lenticular stripes to form a complete image when viewed from a particular angle through the lens. Thus, each of multiple sets of interleaved image strips forms a different image viewable from a different angle so that the viewer, by changing the viewing angle, for example, by tilting the lenticular sheet, can view the different images in succession, thereby producing a novelty effect, such as an illusion of movement.

Halftoning is a printing process using dots of a single colour or a limited number of colours to produce variations in intensity and tone in a printed image. The density of the dots determines the intensity, and the combination of coloured dots, typically selected from cyan, yellow, magenta and black, determines the tone of the printed image. The original image that is to be printed is composed of multiple pixels, each of a known colour intensity and tonal value, and these values for groups of adjacent pixels are processed collectively as a halftone cell using a known algorithm to produce dot printing values corresponding to the dots to be printed for each pixel. This process is repeated across the whole surface of the image to produce the required halftone print.

If the same process were applied to a lenticular image as a whole, ignoring the fact that the lenticular image is in fact composed of multiple images, then artifacts and poor resolution would result in each halftone image as seen by the viewer, because of the highly asymmetric resolution of the cylindrical lenses and boundary effects where adjacent image strips meet.

### SUMMARY OF THE INVENTION

In a first aspect, the invention provides a method of producing a halftone lenticular image from multiple images which are divided into image strips and the strips interleaved to form a lenticular image wherein the image strips of each original image are processed separately from those of other original images to produce corresponding halftone dot printing values for printing the dots of the halftone lenticular image.

According to a first embodiment of the invention, each original image is processed separately as a whole to produce halftone dot printing values for a corresponding halftone image, and the halftone dot printing values for the different halftone images are processed in a sequential manner to output the values of the image strips in the required order to produce the halftone lenticular image.

According to a second embodiment of the invention, the image strips as produced for each original image are processed to produce halftone dot printing values for printing the dots of the halftone lenticular image. The image strips may be processed one at a time or adjacent image strips of each image may be processed together. If image strips are processed one at a time, the halftone cell used preferably has the same width as the image strips or may be a submultiple of the width of the image strips provided the pixels are of a high enough resolution. If adjacent image strips are processed together, the halftone cell can be wider than each image strip.

The halftone cell may be a conventional square cell but it may be preferable to use a halftone cell whose longitudinal dimension along the length of the cylindrical lenses is greater than its width so that it incorporates more pixels along the length of the image strip and gives improved resolution in the halftone dot printing values.

Yet other alternative embodiments of the invention may make use of so called “irregular dispersed” halftoning processes, whereby the halftone cell is replaced by halftone neighbourhoods that can vary in extent and structure with local image characteristics.

However, the neighbourhoods are composed of pixels of only one image at a time.

Halftone neighbourhoods may also be selected so as to increase the contribution from longitudinally spaced pixels so as to give improved printing resolution.

In a second aspect, the invention provides a method of producing a halftone lenticular image from a plurality of original images, comprising: separately halftoning each of the original images to form a plurality of halftoned images; dividing each of the halftoned images into halftoned image strips; and interleaving the halftoned image strips in a required order to form the halftone lenticular image.

In a third aspect, the invention provides method of producing a halftone lenticular image from a plurality of original images, comprising: dividing each of the original images into image strips; interleaving the image strips in a required order for forming a lenticular image to produce an interleaved image; and halftoning the interleaved image to form the halftone lenticular image, wherein in said halftoning the image strips of each original image are processed separately from the image strips of other original images.

In a fourth aspect, the invention provides halftoned lenticular image comprising a plurality of interleaved image strips from a plurality of original images wherein the image strips of each original image have been processed separately from those of other original images to produce corresponding halftone dot printing values for printing the dots of the halftone lenticular image.

In a fifth aspect, the invention provides data carrier carrying a code structure for programming a processor to produce a halftone lenticular image from multiple original images, wherein the code structure is adapted to program the processor to: separately halftone each of the original images to form a plurality of halftoned images; divide each of the halftoned images into halftoned image strips; and interleave the halftoned image strips in a required order to form the halftone lenticular image.

In a sixth aspect, the invention provides a data carrier carrying a code structure for programming a processor to produce a halftone lenticular image from multiple original images, wherein the code structure is adapted to program the processor to: divide each of the original images into image strips; interleave the image strips in a required order for forming a lenticular image to produce an interleaved image; and halftone the interleaved image to form the halftone lenticular image, wherein in said halftoning the image strips of each original image are processed separately from the image strips of other original images.

The invention therefore produces a halftone lenticular image suitable for printing by a standard dot printer and can be used, in appropriate embodiments, with either multiple original images or an original lenticular image.

### BRIEF DESCRIPTION OF THE DRAWINGS

The invention will now be described by way of example with reference to the accompanying drawings:

FIG. 1 shows a lenticular sheet;

FIG. 2 shows the arrangement of image strips in relation to cylindrical lenses in the lenticular sheet of FIG. 1;

FIG. 3 is a schematic diagram of a first embodiment of the invention;

FIG. 4 is a schematic diagram of a second embodiment of the invention;

FIG. 5 is a schematic diagram of the pixels in a lenticular image;

FIG. 6 is a schematic diagram of a halftoning process used according to a third embodiment of the invention; and

FIG. 7 shows exemplary apparatus for carrying out embodiments of the invention.

### DESCRIPTION OF THE PREFERRED EMBODIMENTS

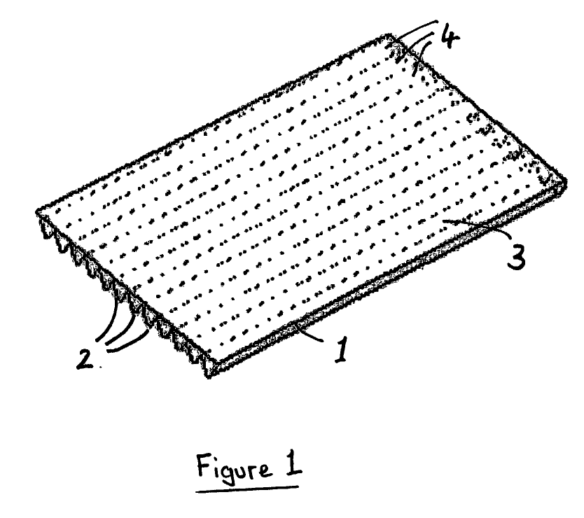

The lenticular sheet shown in FIG. 1 comprises a transparent acrylic sheet 1 formed with a flat rear surface and a ridged front surface in which the ridges 2 extend parallel to one another and each ridge 2 forms a cylindrical lens. A printed sheet 3 is attached to the rear surface of the acrylic sheet 1 and carries a lenticular image L comprising multiple equal width, parallel lenticular stripes 4, each aligned longitudinally with a respective cylindrical lens 2.

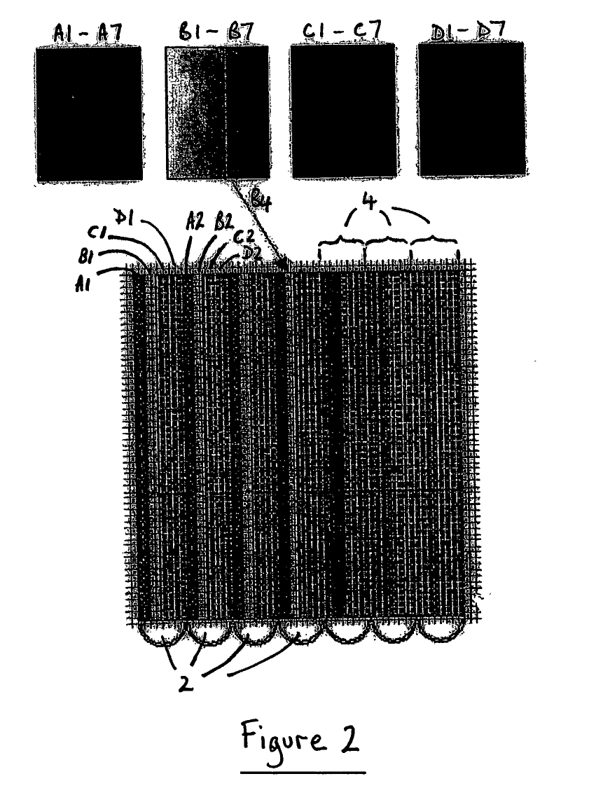

The stripes 4 are all of equal width and each is composed of multiple image strips 5, each strip 5 being derived from a corresponding original image, which is to be incorporated into the lenticular image. As shown in FIG. 2, there are four original contone images A, B, C, D, each divided into seven image strips A1 to A7, B1 to B7, C1 to C7 and D1 to D7, and successive ones of the image strips from each original image are incorporated into successive ones of the lenticular stripes 4. Thus, the first stripe 4 is composed of four image strips A1, B1, C1, D1; the second stripe 4 alongside the first is composed of four image strips A2, B2, C2, D2; and so on for all seven stripes 4. The arrangement of the strips A to D in relation to each of the cylindrical lenses 2 is such that only the strips A1 to A7 are visible to a viewer as seen from the front of the sheet 1 at a first viewing angle, only strips B1 to B7 are visible to the viewer as seen from a second viewing angle, and so on for each of the groups of strips C1 to C7 and D1 to D7 each seen from respective viewing angles. Therefore, the viewer sees each of the original images as a composite of its image strips 5 when viewed at a unique angle. This is the known characteristic of lenticular images, which is exploited to produce certain novelty effects.

It will be appreciated that the lenticular image L, is composed of a number of contone images, and is itself a contone image which is to be printed on the sheet 3.

According to a first embodiment of the invention illustrated in FIG. 3 each of the four original contone images A to D is processed separately as a whole to produce a corresponding halftone image A′, B′, C′ and D′. Various known halftoning algorithms may be used to convert individual or groups of pixels from each original image A to D into halftone dot printing values which are stored as the halftone images A′ to D′. The halftone dot printing values of each halftone image are then sampled to output values from each of seven successive, equal width, parallel strips of the halftone image A′1 to A′7, B′1, C′1 to C′7, D′1 to D′7. These strip values are interleaved as they are sampled so as to produce a halftone lenticular image HL consisting of parallel stripes 4, each including a corresponding one of the image strips from each of the halftone images; A′1, B′1, C′1, D′1; A′2, B′2, C′2, D′2; etc. up to the seventh stripe A′7, B′7, C′7, D′7. This halftone lenticular image HL is printed by a dot printer, such as a jet printer, which takes the sampled interleaved strip values as the driving input.

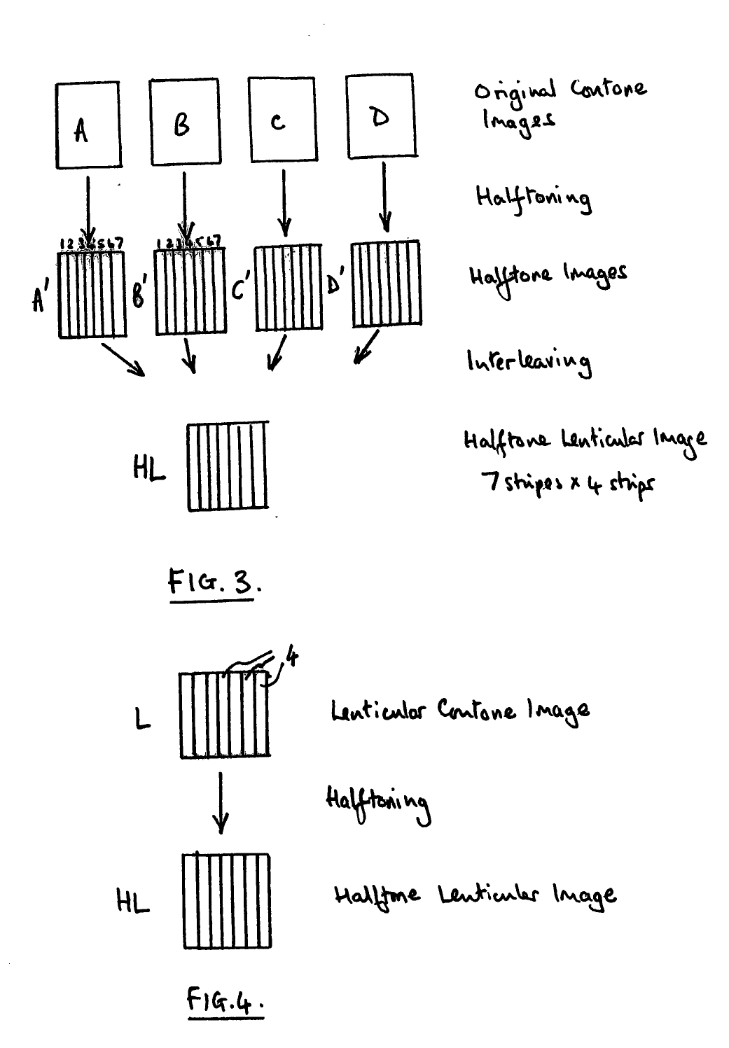

According to a second embodiment of the invention illustrated in FIG. 4, the lenticular contone image L of FIG. 2 is processed to produce a halftone lenticular image HL consisting of the same number of lenticular stripes 4 and strips 5, pixels from the contone image L being converted into corresponding dot printing values for feeding to a dot printer that prints the halftone lenticular image. The conversion from pixels to dot printing values may proceed on a pixel by pixel basis. Alternatively, multiple pixels may be processed simultaneously to produce corresponding dot printing values, the pixels all being selected from the same strip 5 each time. Multiple pixels are selected on the basis of a halftone cell which is either the same width as the strip or is a sub-multiple of the width of the strip. Standard halftoning algorithms may be used for this conversion.

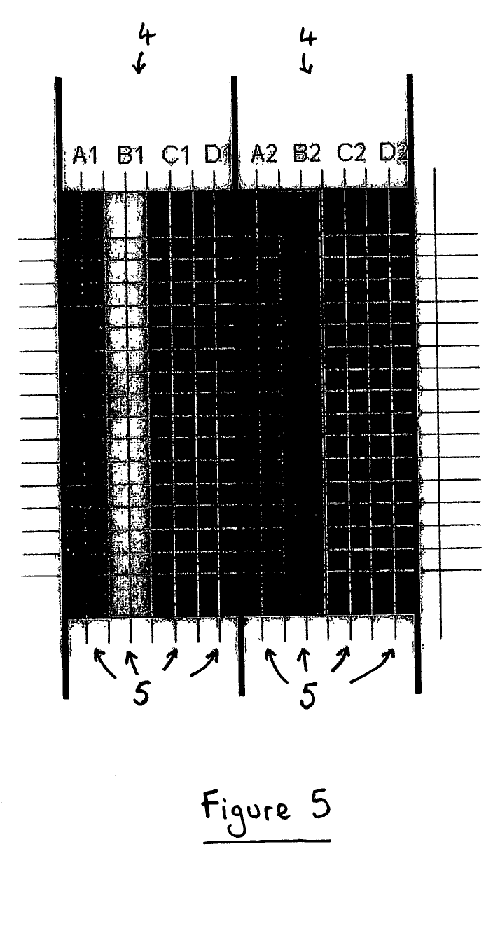

FIG. 5 illustrates an arrangement of pixels for two adjacent lenticular stripes 4, each composed of four strips 5: A1, B1, C1, D1 and A2, B2, C2, D2. The pixels define a square grid with each strip 4 being two pixels wide. Therefore, a halftone cell two pixels square may be used to convert a square array of pixels across the full width of each strip 5 into corresponding dot printing values. Alternatively, smaller pixels will allow a larger number to be accommodated within the width of each strip 5 so that a halftone cell two pixels square may be applied twice for a strip four pixels wide, or more often for even smaller pixels. The limit in size of pixels will be determined by the resolution of the dot printer.

This conversion of pixels to dot printing values is conducted in a sequential manner across the whole of the lenticular contone image L so as to produce a continuous output of dot printing values for the printer. This embodiment of the invention therefore runs as an online process to produce a halftone lenticular image from a contone lenticular image.

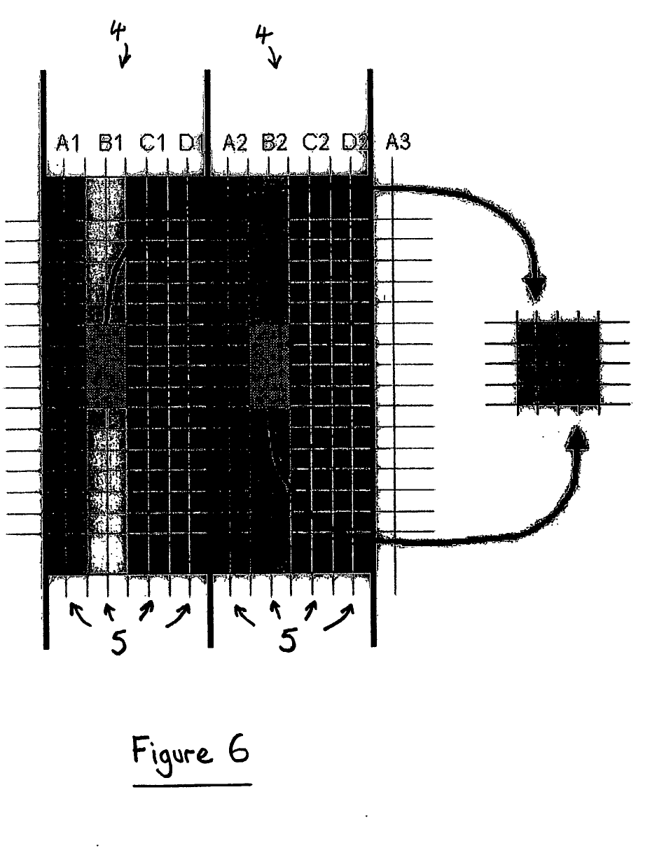

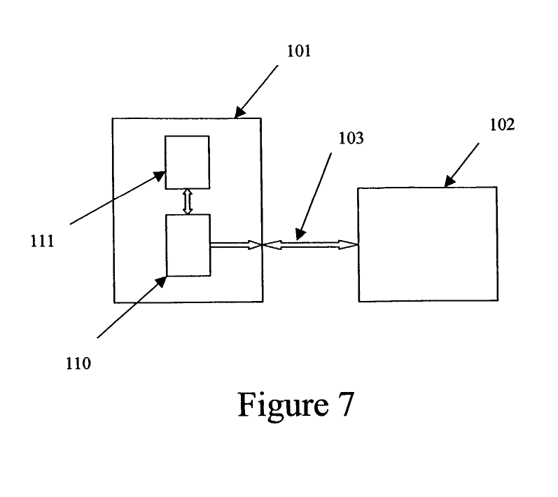

A third embodiment of the invention illustrated in FIG. 6, is similar to that of FIG. 4 in that a halftone lenticular image HL is generated from the lenticular contone image L, but the halftoning process used is different in that it makes use of pixels from different strips 5 of the same original image to produce each set of corresponding dot printing values.

As shown in FIG. 6, the strips are two pixels wide, and a halftone cell four pixels square is used to convert adjacent pixels of two strips 5 of the same original image in neighbouring lenticular stripes 4 into dot printing values. For example, FIG. 6 indicates that the adjacent pixels of strips B1 and B2 in neighbouring stripes are processed together in the halftone cell, each contributing 2×4 pixels to the 4×4 halftone cell. The physical separation of the two strips B1 and B2 is therefore counteracted, and the halftone processing gives improved results because of the large pixel sample whilst avoiding adverse boundary effects where neighbouring strips such as B1 and C1 meet. The conversion of pixels to dot printing values is performed in a sequential manner across the whole of the lenticular contone image L to produce a continuous printing output, as in the embodiment of FIG. 6.

According to a fourth embodiment of the invention, the halftoning process used in the embodiment of FIG. 6 may be an irregular dispersed halftoning process instead of that of a predefined halftone cell. This alternative halftoning process is well known and involves using pixels in neighbourhoods that may vary in extent and structure with the local image characteristics and may include error diffusion. However, pixels of all neighbourhoods are selected so that they come from the strips 5 of the same original image at any one time to produce corresponding dot printing outputs.

According to another embodiment of the invention, the halftone square cell used in the second embodiment of FIGS. 4 and 5, or the third embodiment of FIG. 6 is replaced by a halftone cell which is longer than it is wide so as to make more use of the longitudinally aligned pixels in each strip to give improved resolution in the halftone lenticular image. For example, the square 2×2 halftone cell of the second embodiment may be replaced by a 3×2 halftone cell.

The same principle of making more use of the longitudinally spaced pixels available in each strip can be applied to the irregular dispersed halftoning process of the fourth embodiment, the neighbourhoods used being more elongated longitudinally. For example, the diffusion kernel of the Floyd and Steinbeck error diffusion technique or other similar techniques can be elongated so as to favour more use of the longitudinally aligned pixels.

The apparatus necessary to carry out the method may be essentially conventional in form. An essentially conventional computing apparatus 101 (such as a PC) with sufficient computational power in its processor 110 and sufficient memory 111 to handle the necessary degree of image processing can carry out all the steps up to provision of the values necessary for printing the halftone lenticular image. These values are then sent to any printer 102 adapted to printing lenticular images through an appropriate communications infrastructure 103.

1. A method of producing a halftone lenticular image from multiple images which are divided into image strips and the strips interleaved to form a lenticular image wherein the image strips of each original image are processed separately from those of other original images to produce corresponding halftone dot printing values for printing the dots of the halftone lenticular image.

2. A method as claimed in claim 1 wherein each original image is processed separately as a whole to produce halftone dot printing values for a corresponding halftone image, and that the halftone dot printing values for the different halftone images are processed in a sequential manner to output the values of the image strips in the required order for the halftone lenticular image.

3. A method as claimed in claim 1 wherein the image strips as produced for each original image are processed to produce halftone dot printing values for printing the dots of the halftone lenticular image.

4. A method as claimed in claim 3 wherein pixels of the image strips are processed separately for each strip to produce the halftone dot printing values.

5. A method as claimed in claim 3 wherein pixels of adjacent image strips of each original image are processed together to produce the halftone dot printing values.

6. A method as claimed in claim 1 in which pixels of the image strips are processed to produce the halftone dot printing values, the processing for each halftone dot printing value involving more pixels along the length of the strip than across its width.

7. A method as claimed in claim 1 wherein pixels of the image strips are processed as a neighbourhood array using an irregular dispersed halftoning process to produce the halftone dot printing values.

8. A method as claimed in claim 12 wherein the neighbourhood array has a greater longitudinal extent than width.

9. A method of producing a halftone lenticular image from a plurality of original images, comprising:
separately halftoning each of the original images to form a plurality of halftoned images;
dividing each of the halftoned images into halftoned image strips;
interleaving the halftoned image strips in a required order to form the halftone lenticular image.

10. A method as claimed in claim 9, wherein said plurality of halftoned images each comprise halftone dot printing values for printing a halftone image, and wherein said interleaving comprises processing the halftone dot printing values for the different halftoned images in a sequential manner to output the values of the halftoned image strips in the required order for the halftone lenticular image.

11. A method as claimed in claim 10 wherein pixels of the original images are processed as a neighbourhood array using an irregular dispersed halftoning process to produce the halftone dot printing values.

12. A method of producing a halftone lenticular image from a plurality of original images, comprising:
dividing each of the original images into image strips;
interleaving the image strips in a required order for forming a lenticular image to produce an interleaved image;
halftoning the interleaved image to form the halftone lenticular image, wherein in said halftoning the image strips of each original image are processed separately from the image strips of other original images.

13. A method as claimed in claim 12 wherein the image strips as produced for each original image are processed to produce halftone dot printing values for printing the dots of the halftone lenticular image.

14. A method as claimed in claim 13 wherein pixels of the image strips are processed separately for each strip to produce the halftone dot printing values.

15. A method as claimed in claim 14 wherein the pixels are processed as a halftone cell.

16. A method as claimed in claim 15 wherein the halftone cell has substantially the same width as the image strips.

17. A method as claimed in claim 15 wherein the width of the halftone cell is a submultiple of the width of the image strip.

18. A method as claimed in claim 13 wherein pixels of adjacent image strips of each original image are processed together to produce the halftone dot printing values.

19. A method as claimed in claim 17 wherein the pixels are processed as a halftone cell, and wherein the halftone cell has substantially the same width as both of the adjacent image strips.

20. A method as claimed in claim 12 in which pixels of the image strips are processed to produce the halftone dot printing values, the processing for each halftone dot printing value involving more pixels along the length of the strip than across its width.

21. A method as claimed in claim 12 wherein pixels of the image strips are processed as a neighbourhood array using an irregular dispersed halftoning process to produce the halftone dot printing values.

22. A method as claimed in claim 21 wherein the neighbourhood array has a greater longitudinal extent than width.

23. A halftoned lenticular image comprising a plurality of interleaved image strips from a plurality of original images wherein the image strips of each original image have been processed separately from those of other original images to produce corresponding halftone dot printing values for printing the dots of the halftone lenticular image.

24. A data carrier carrying a code structure for programming a processor to produce a halftone lenticular image from multiple original images, wherein the code structure is adapted to program the processor to:
separately halftone each of the original images to form a plurality of halftoned images;
divide each of the halftoned images into halftoned image strips;
interleave the halftoned image strips in a required order to form the halftone lenticular image.

25. A data carrier carrying a code structure for programming a processor to produce a halftone lenticular image from multiple original images, wherein the code structure is adapted to program the processor to:
divide each of the original images into image strips;
interleave the image strips in a required order for forming a lenticular image to produce an interleaved image;
halftone the interleaved image to form the halftone lenticular image, wherein in said halftoning the image strips of each original image are processed separately from the image strips of other original images.
